(19) United States
(12) Patent Application Publication
(10) Pub. No.: US 2012/0202630 A1
(43) Pub. Date: Aug. 9, 2012

(54) METHOD AND APPARATUS FOR SELECTIVE MECHANICAL ENTRAINMENT

(76) Inventor: JACK M. GOLDWASSER, GRANTS PASS, OR (US)

(21) Appl. No.: 13/021,750

(22) Filed: Feb. 5, 2011

(51) Int. Cl. F16H 7/06; F16H 55/30

(52) U.S. Cl. 474/148; 474/158

(57) ABSTRACT

A method and systems for disengagement of a chain and sprocket actuation system is provided. In one version, an actuation system mechanically couples a motor with a rotatable feature. The rotatable feature may be a threaded stem that alternately raises and lowers a gate as the feature is rotated in a respective direction. A removable key comprised within the actuation key. When the key is removed from engagement with the motor, that rotatable feature is decoupled from the motor. A manual fixture, such as a wheel, may be used to rotate the rotatable feature by hand. The rotatable feature may thus be driven by the motor, or alternately decoupled from the motor and driven by hand.

### FIELD OF THE INVENTION

The present invention relates generally to mechanical entrainment method san systems. The present invention more particularly relates to methods and systems to alternately and selectively couple with, and decouple from, a source of mechanical force and a movable object.

### BACKGROUND OF THE INVENTION

The prior art includes methods and systems that couple sources of mechanical force with rotatable objects, such as shafts. Yet in the course of the use of many mechanical systems, a first source of mechanical force may fail, or a second source may be preferred over the first source. For example, a motor that is coupled with a threaded stem may fail to perform due to lack of fuel. Where the motor is coupled with the threaded stem, or other rotatable object, by an actuation system, alternate rotation of the object or threaded stem by means other than the motor may be impeded by that actuation system.

There is a long-felt need to provide methods and systems that selectively enable an engagement of an object with a first source of mechanical force and alternately allows the first source to be selectively decoupled.

### OBJECTS OF THE INVENTION

It is a principal object of the present invention to provide an actuation system that allows selective decoupling of the system from source mechanical force and an object.

Another object of the invention is to provide a reliable system for the purpose described herein.

### SUMMARY OF THE INVENTION

This and other objects of the present invention are made obvious in light of this disclosure, wherein a method and system for selectively engaging a movable object with at least two alternate sources of mechanical force are provided.

According to a first aspect of the method of the present invention, an actuation assembly includes a removable coupling key, wherein the actuation assembly transfers mechanical force form a mechanical force source, such as a motor, to a moveable object, such as a rotatable force. When the removable coupling key is disengaged from the remainder of the actuation assembly, the mechanical force source is decoupled from the moveable object, and mechanical force is no longer transferred from the mechanical force source to the moveable object. The removable key may then be reengaged to again enable the actuation system, wherein the mechanical force source is again mechanically coupled with the moveable object

According to a second aspect of the method of the present invention, a system provides selective connectivity between a drive shaft of a motor with a threaded stem, such as a lead screw. The removable coupling key is disposed between the drive shaft and a first sprocket. A link chain receives and transfers rotational force from the first sprocket to the threaded stem. A second sprocket, may be entrained to the threaded stem and be disposed between the link chain and the threaded stem, whereby mechanical force is translated from the drive shaft through the removable key, the first sprocket, the link chain, and to the threaded stem. A threaded nut may be attached to or coupled with the second sprocket, wherein the threaded nut is limited in linear motion that is orthogonal to the direction of rotation of the second sprocket and the resultant rotation of the threaded stem. Turning the second sprocket as driven by the link chain causes the threaded nut to rotate the threaded stem. Removing the coupling key disengages and decouples the motor drive shaft from the first sprocket, and thereby reduces inhibition of manual rotation of the threaded stem by the actuation system.

According to a third aspect of the method of the present invention, the motor drive shaft may provide mechanical force that is transferred through the removable key to a first pulley, from the first pulley to a cable, from the cable to a second pulley, and from the second pulley to a rotatable object.

According to a fourth aspect of the method of the present invention, the threaded nut coupled with the second sprocket or second pulley may be rotatably coupled with, or restrained by, a fixture, such as a plate, to maintain the threaded nut in position relative to the sprocket and yet allow free rotation of the threaded nut to drive the threaded stem.

According to a fifth aspect of the method of the present invention, the actuation system may further comprise a manual fixture that enables manual rotation of the threaded stem, preferably when the removable coupling key is disengages from the remainder of the actuation system. The manual fixture may be a wheel or one or more handles.

According to a fifth aspect of the method of the present invention, the actuation system may be or comprise a gate that is movable for the purpose of alternately impeding and allowing a fluid to flow, such as water in an irrigation channel. The threaded stem may be coupled to the gate.

According to a fifth aspect of the method of the present invention, a drive sprocket and a driven sprocket of an actuation system are mounted on a threaded gate stem. The driven sprocket is coupled to both the threaded gate stem and to a chain. The chain is additionally coupled to a drive sprocket, wherein the drive sprocket is alternately driven in a clockwise direction and a counterclockwise direction by a motor. The gate stem rises through a threaded drive-nut. The threaded drive-nut is mounted into the driven sprocket and is further captured by a retaining plate or collar. The retaining plate and/or collar causes the gate stem to rise or descend in correspondence as the driven sprocket turns alternately clockwise and counterclockwise. The drive sprocket may be mounted on the drive motor and be machined to accept a removable locking key, or “drive key”. When the drive key is in place, the drive key accepts rotational force of a drive shaft of the motor, whereupon the drive key transfers the rotational force to the drive sprocket. The drive sprocket thereupon turns the chain, and the chain engages with and turns the driven sprocket. When removed the drive key is removed from engagement with the drive shaft and the drive sprocket, the drive shaft spins freely and allowing a manual operation of the driven sprocket. A hand-wheel may be used to manually turn the threaded gate stem. Electrical fusing of the motor provides over-torque protection of the motor.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

Such incorporations include U.S. Pat. No. 7,255,128 (inventors: Sandhu, et al.; issued on Aug. 14, 2007) titled “System and method for detecting flow in a mass flow controller”; U.S. Pat. No. 5,967,697 (inventors: Larsen, et al.; issued on Oct. 19, 1999), titled “Flood control gate safety device”; U.S. Pat. No. 4,877,352 (inventors: Tuttle, et al.; issued on Oct. 31, 1989) titled “Method and apparatus for control of an upstream water level”; U.S. Pat. No. 3,952,522 (inventor Shettel, R.; issued on Apr. 27, 1976) titled “Irrigation systems automation”; U.S. Pat. No. 3,354,655 (inventor: Armond, Charles V.; issued on Nov. 28, 1967), titled “Automatically operated door for water control”; U.S. Pat. No. 2,979,909 (inventor: Stanley, Broadbent; issued on Apr. 18, 1961), titled “Sluice Gate”; U.S. Pat. No. 2,361,439 (inventor: Samuel, Weiss; issued on Oct. 31, 1944), titled Torque control switch; and U.S. Pat. No. 2,041,576 (inventor: Alfred, Suksdorf; issued on May 19, 1936), titled “Control system”.

The publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE FIGURES

These, and further features of various aspects of the present invention, may be better understood with reference to the accompanying specification, wherein:

FIG. 1 is a side view of a first actuation system in a first operational state, whereby a threaded stem is entrained with a motor-driven drive shaft;

FIG. 2 is a top view of the first actuation system of FIG. 1 in the first operational state;

FIG. 3 is a top view of the first actuation system of FIG. 1 and FIG. 2 in a second operational state, whereby the threaded stem is decoupled with the motor-driven drive shaft by removal of a drive key from engagement with the drive shaft;

FIG. 4 is a side view of a second actuation system in a first operational state, the second actuation including comprising a drive pulley mechanically coupled by a belt with a driven pulley, whereby the threaded stem is entrained with the motor-driven drive shaft;

FIG. 5 is a top view of the second actuation system of FIG. 4 in the first operational state;

FIG. 6 is a side view of an alternate configuration of the first actuation system of FIGS. 1, 2 and 3 further comprising a plate to which the threaded nut and first sprocket are both rotatably coupled;

FIG. 7 is a side view of a still alternate configuration of the first actuation system of FIGS. 1, 2, 3 and 6 further comprising a flow control gate that is coupled with a bottom end of the threaded stem;

FIG. 8 is a side view of a yet alternate configuration of the first actuation system of FIGS. 1, 2, 3, 6 and 7 further comprising a hand wheel that is coupled with the threaded nut;

FIG. 9 is a partial, detailed cut-way side-view of an alternate version system of the first actuation system of FIGS. 1, 2, 3, 6 and 7;

FIG. 10 is a top view of the alternate version system of the first actuation system FIG. 9; and

FIG. 11 is a top view of the alternate version system of the first actuation system FIG. 9 and FIG. 10.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

In the following detailed description of the invention, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

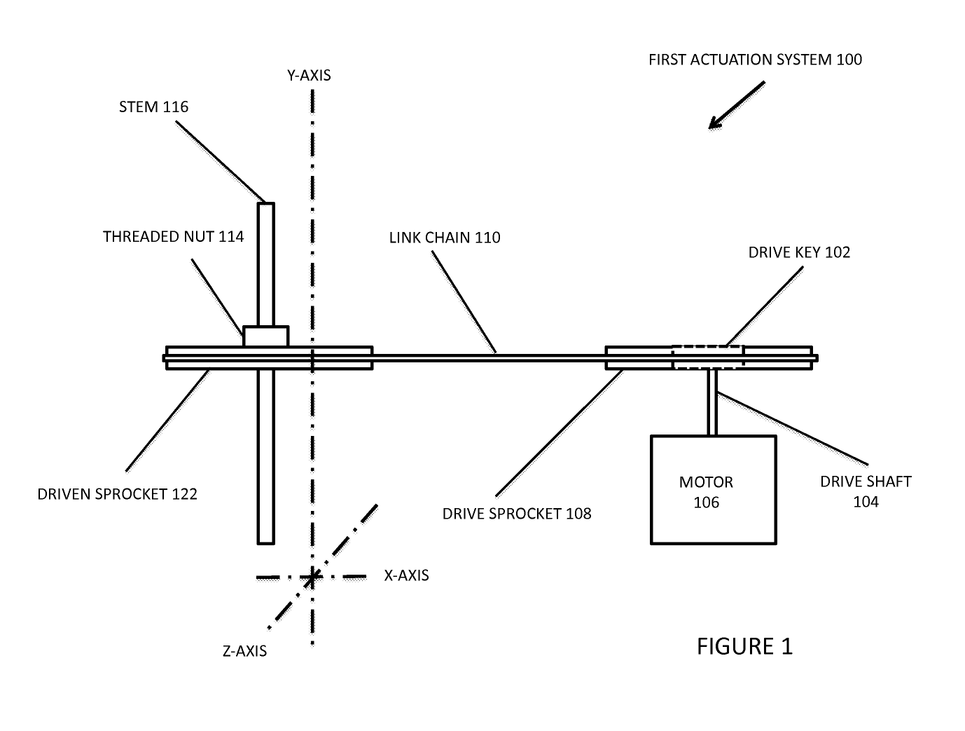

Referring now generally to the Figures and particularly to FIG. 1, FIG. 1 is a side view of a first actuation system 100. The first actuation system 100 includes a drive key 102 that is removably disposed between a drive shaft 104 of a motor 106 and a drive sprocket 108. The motor 106 may be an alternating current motor or a direct current motor in alternate preferred embodiments of the present invention.

When engaged for entrainment within the first actuation system 100, the drive key 102 is placed within a centered drive sprocket aperture 108A of the drive sprocket 108 and transfers rotational force from the drive shaft 104 to the drive sprocket 108 via the link chain 110. The drive sprocket 108 engages the link chain 110 to entrain a second, driven sprocket 112. The driven sprocket 112 is rotated by the link chain 110 as the drive sprocket 108 receives and transfers mechanical force originating from the drive shaft 104. The driven sprocket 112 is additionally coupled with a captured threaded nut 114, whereby the driven sprocket 112 rotates the captured threaded nut 114 about a Y-axis when, and as, the link chain 110 rotates the driven sprocket 112.

The threaded nut 114 is captured in relation to the link chain 110 and the driven sprocket 112 within an X-Z axis. When the threaded nut 114 is turned clockwise or counter-clockwise about the Y-axis, the threaded nut 114 engages with a threaded stem 116 to alternately move the threaded stem 116 up and down along the Y-axis. More specifically, a mechanical engagement of an inner threaded channel 118 of the threaded nut 114 with the threaded stem 116 causes the threaded stem 116 to travel along the Y-axis as the threaded nut 114 is alternately rotated clockwise or counter clockwise about the Y-axis.

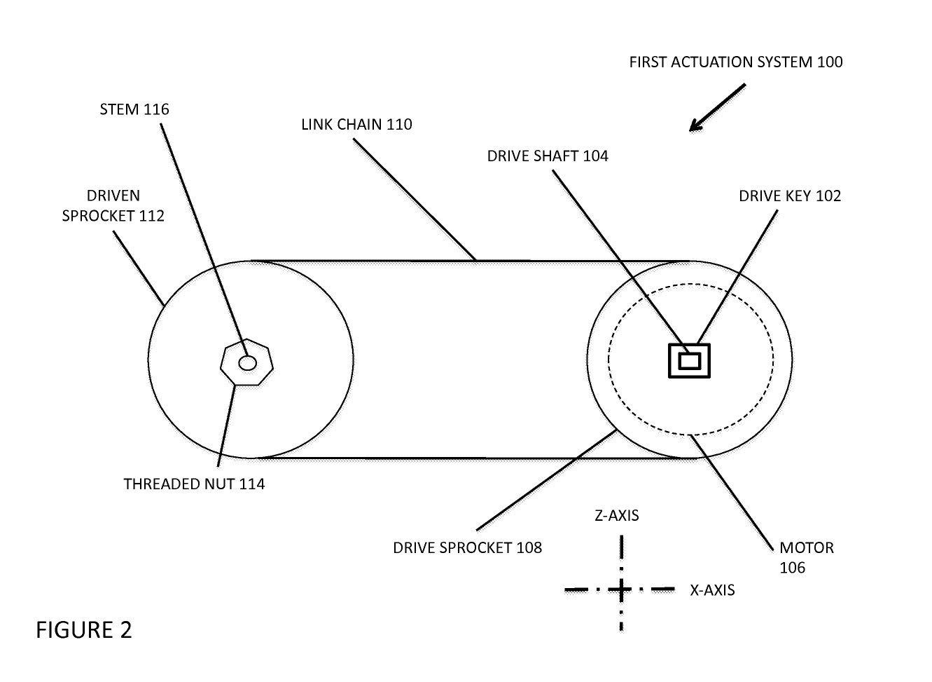

Referring now generally to the Figures and particularly to FIG. 2, FIG. 2 is a top view of the first actuation system 100. The drive sprocket 108 and the driven sprocket 112 are preferably co-planar and aligned within an operating plane defined by an X-axis and a Z-axis, wherein the Y-axis of FIG. 1, the Z-axis of FIG. 2, and the X axis of FIG. 1 and FIG. 2 are all three mutually orthogonal. The drive key 102 is depicted in both FIG. 1 and FIG. 2 in a first state operational state wherein the drive key 102 is disposed between the drive shaft 104 of the motor 106 and the drive sprocket 108. The drive key 102 is positioned when in the first operational state of the first actuation system 100 to transfer rotational force in either a clockwise direction, or alternately in a counter clockwise direction, from the drive shaft 104 and to the drive sprocket 108.

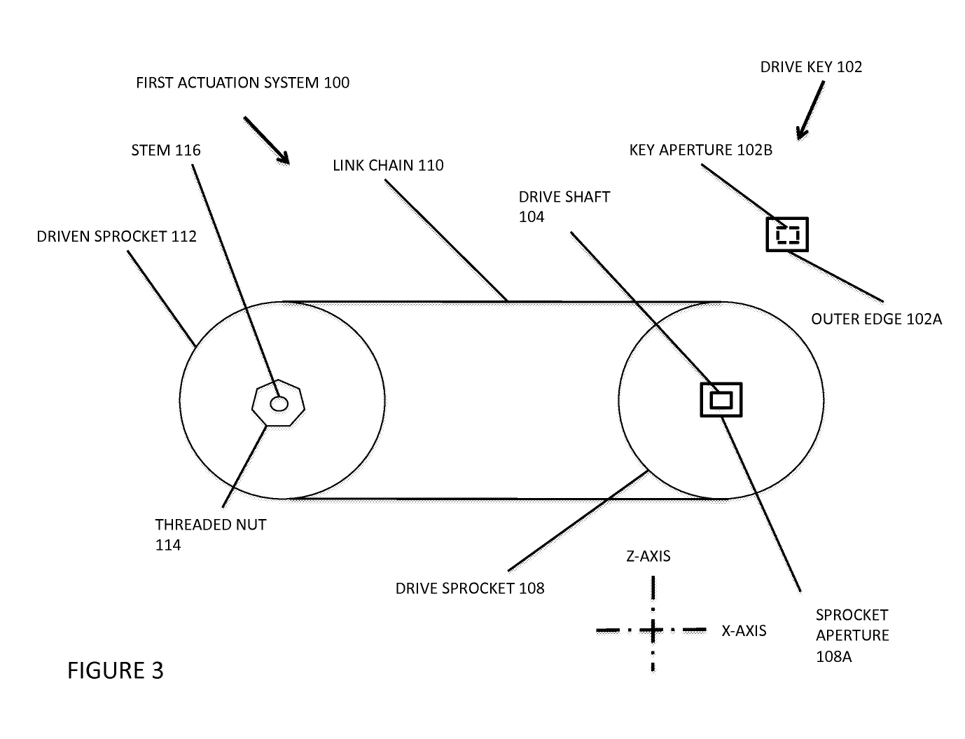

Referring now generally to the Figures and particularly to FIG. 3, FIG. 3 is a top view of the first actuation system 100, wherein the drive key 102 has been placed into a second operational state by removal of the drive key 102 by a user from engagement with either the drive shaft 104 or the drive sprocket 108. A central drive sprocket aperture 108A of the drive sprocket 108 is shaped to receive and retain the drive key 102. An outer edge 102A of the drive key 102 is sized and shaped to fit within the drive sprocket aperture 108A to engage with the drive sprocket 108 when the drive key 102 is placed in the first operational state. A key aperture 1028 of the drive key 102 is shaped and sized to receive the drive shaft 104 and to enable a transfer of rotational force from the drive shaft 104 when the drive key 102 is positioned in the first operational state and within the drive sprocket aperture 108A.

As shown in FIG. 3, when the drive key 102 is placed into the second operational state wherein the drive key 102 is removed from engagement or contact with the drive sprocket aperture 108A, the drive shaft 104 does not engage with the drive sprocket 108 through the drive key 102 or other means, and the first actuation system 100 therefore does not entrain the threaded stem 116 with the drive shaft 104. The threaded stem 116 is thus available to receive rotational force from an alternative force that the motor 106, and without inhibition by any resistive force generated by, or delivered from, the motor 106, when the first actuation system 100 is placed into the second operational state by removal of the drive key 102 from contact with the drive sprocket 108.

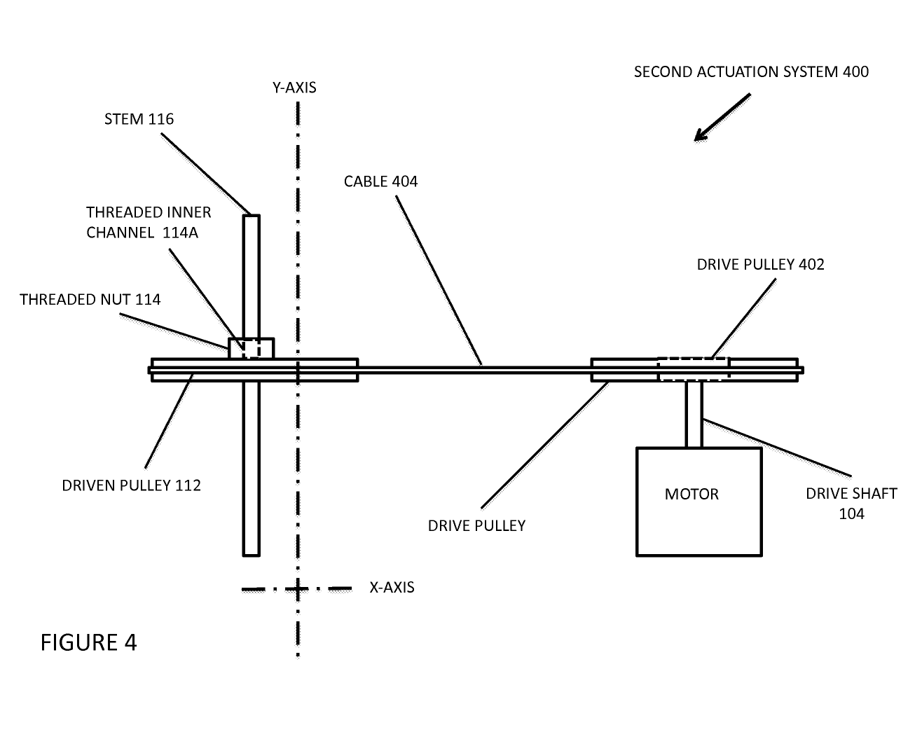

Referring now generally to the Figures and particularly to FIG. 4, FIG. 4 is a side view of a second actuation system 400. The second actuation system 400 includes the drive key 102 that is illustrated in FIG. 4 to be removably disposed between the drive shaft 104 and a drive pulley 402. When engaged for entrainment within the second actuation system 400, the drive key 102 is placed within a central pulley aperture 402A of the drive pulley and transfers rotational force from the drive shaft 104 to the drive pulley 402. The drive pulley 402 further engages a cable 404 to entrain a second, driven pulley 406. It is understood that the cable 404 may be a belt.

The driven pulley 406 is rotated by the cable 404 as the drive pulley 402 receives and transfers mechanical force originating from the drive shaft 104. The driven pulley 206 is additionally coupled with the captured threaded nut 114, whereby the driven pulley 406 rotates the captured threaded nut 114 about the Y-axis when, and as, mechanical force received from the cable 404 rotates the driven pulley 406. The threaded nut 114 is captured In relation to the cable 404 and driven pulley 406 and, when turned, forces the threaded stem 116 to alternately up and down along the Y-axis.

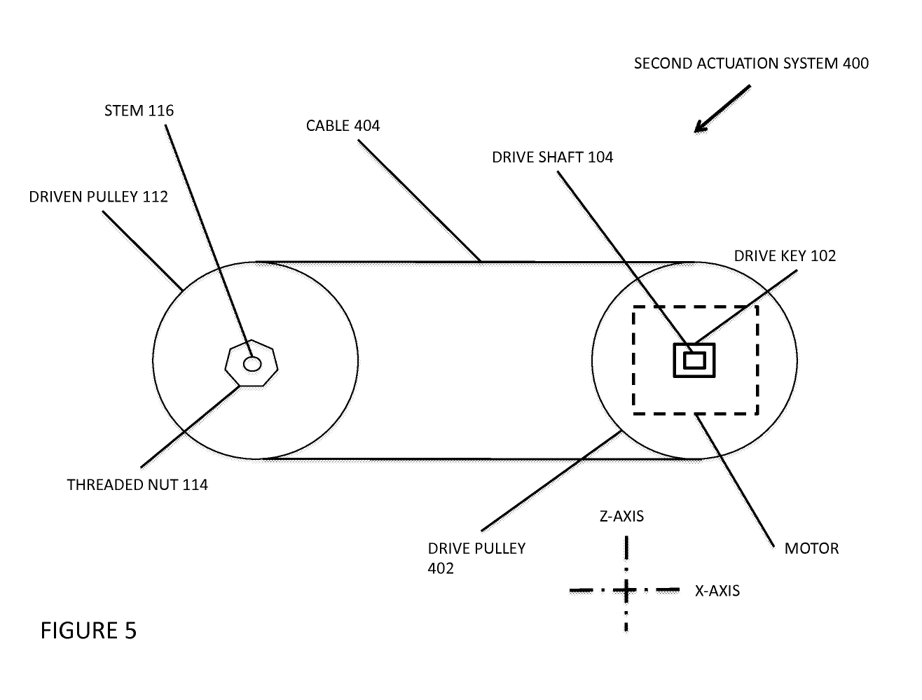

Referring now generally to the Figures and particularly to FIG. 5, FIG. 5 is a top view of the second actuation system 400. The drive pulley 402 and the driven pulley 406 are preferably co-planar and are each aligned within the operating plane defined by the X-axis and the Z-axis. The drive key 102 is depicted in both FIG. 4 and FIG. 4 in a first operational state of the second actuation system 400, wherein the drive key 102 is disposed between the drive shaft 104 of the motor 106 and the drive pulley 402. The drive key 102 is positioned when in the first operational state of the second actuation system 400 to transfer rotational force in either a clockwise direction, or alternately in a counter clockwise direction, from the drive shaft 104 and to the drive pulley 402.

The second actuation system 400 may be placed into the second operational state by removal of the drive key 102 by the user from engagement or contact with the drive pulley aperture 402A, wherein the drive shaft 104 does not engage with the drive pulley 402 through the drive key 102 or other means, and the second actuation system 400 therefore does not entrain the threaded stem 116 with the drive shaft 104. The threaded stem 116 is thus available to receive rotational force from an alternative force other than the motor 106, and without inhibition by any resistive force generated by, or delivered from, the motor 106 when the second actuation system 400 is placed into the second operational state by removal of the drive key 102 from contact with the drive pulley.

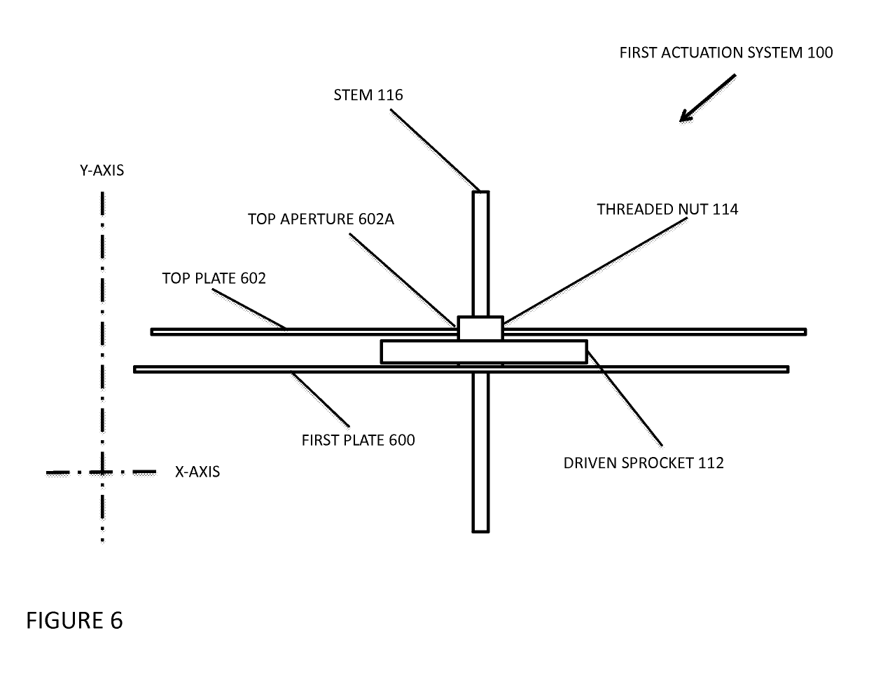

Referring now generally to the Figures and particularly to FIG. 6, FIG. 6 is a side view of an alternate configuration of the first actuation system 100 further comprising a first plate 600 to which the threaded nut 114 and driven sprocket 112 are rotatably coupled, and a top plate 602 having a top plate aperture 602A through which both the stem 116 and the threaded nut 114 extend. The first plate 600 and the top plate 602 captures and maintains the threaded nut 114 substantively within the X-Z plane while allowing the threaded nut 114 to be rotated, whereby the engagement of the inner threaded channel 114A of the threaded nut with the threaded stem 116 causes the threaded stem 116 to travel along the Y-axis as the threaded nut 114 is alternately rotated clockwise or counter clockwise about the Y-axis. A

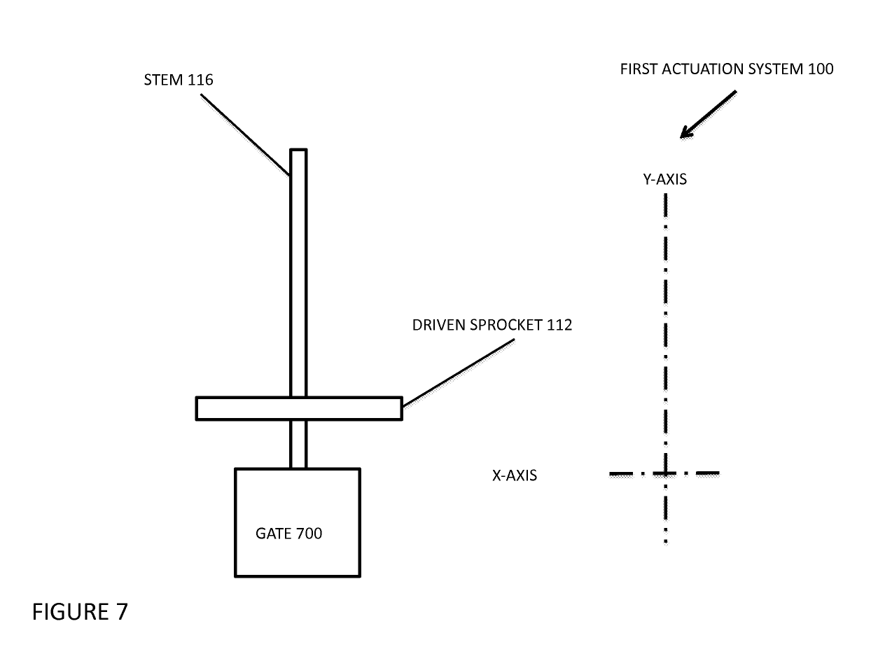

Referring now generally to the Figures and particularly to FIG. 7, FIG. 7 is a side view of a still alternate configuration of the first actuation system 100 further comprising a flow control gate 700 that is coupled with a bottom end of the threaded stem 116. As the driven sprocket 112 alternately is rotated the clockwise and counter clockwise the threaded stem 116 alternately raises and lowers the control gate 116 along the Y-axis, whereby fluid (not shown), such as irrigation water, is alternately released and contained.

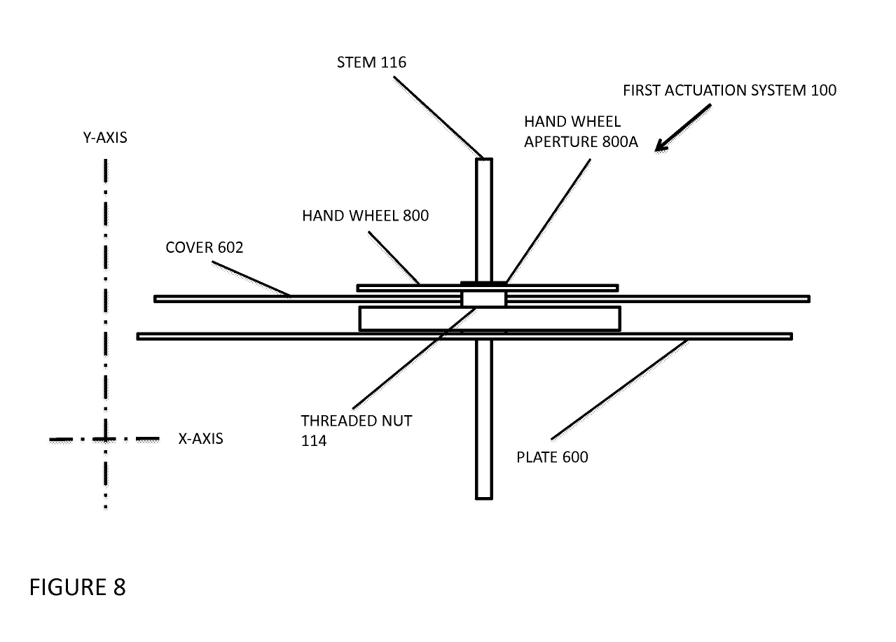

Referring now generally to the Figures and particularly to FIG. 8, FIG. 8 is a side view of a yet alternate configuration of the first actuation system 100 further comprising a hand wheel 800 removably coupled with the threaded nut 114. A hand wheel aperture 800A is sized and shaped to extend about the stem 116 and engage with the threaded nut 114 sufficiently to enable transfer of manual force applied by the user to the hand wheel 800 to the threaded nut 114 and therefrom to the threaded stem 116, whereby the user may manually position the threaded stem 116 alternately up and down the Y-axis.

More particularly, the user may turn the hand wheel 800 by manually applying force to cause the threaded nut 114 to alternately rotate clockwise or counter-clockwise about the Y-axis. This rotation of the threaded nut alternately causes the threaded stem 116 to travel in one of the two directions of the Y-axis. This movement of the threaded stem 116 causes the gate 700 that is coupled to the threaded stem 116 to move up or down along the Y-axis in entrainment with the threaded stem 116.

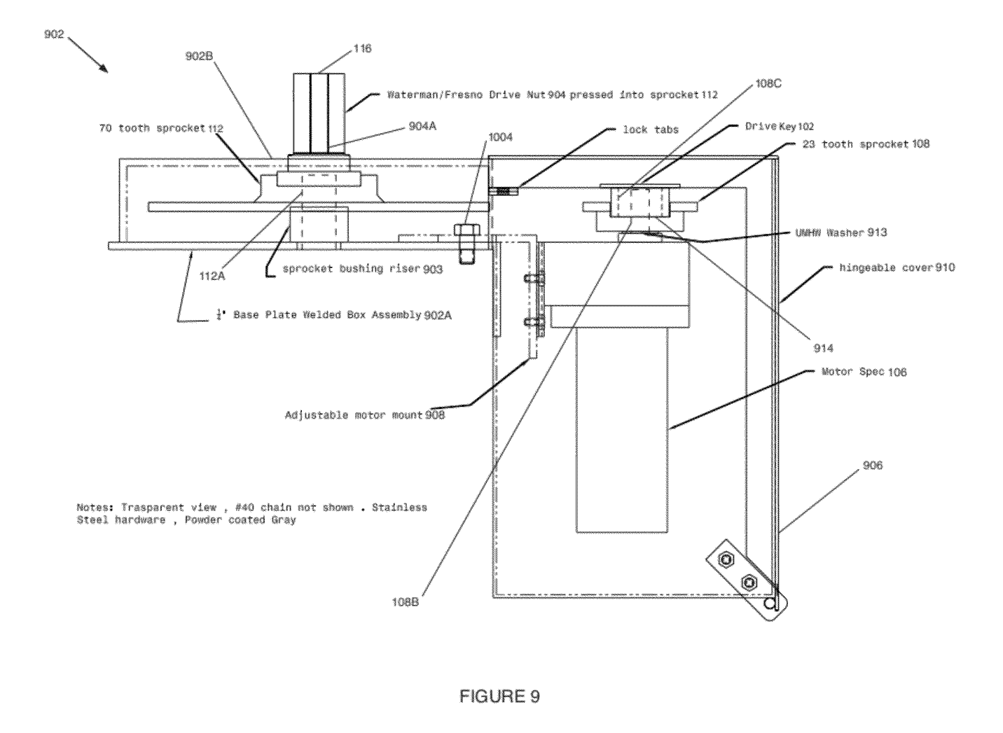

Referring now generally to the Figures and particularly to FIG. 9, FIG. 9 is a partial, detailed cut-way side-view of an alternate version system 900 of the first actuation system 100. A box assembly 902 partially encloses the seventy tooth driven sprocket 112. A fixed tubular sprocket-bushing riser 903 extends from a bottom box plate 902A of the box assembly 902 and into a driven sprocket aperture 112A. A Waterman/Fresno drive nut 904 is press-fit into the driven sprocket 112, and presents an inner threaded channel 904A that engages with the threaded stem 116. The driven sprocket 112 is constrained from moving along the Y-axis by containment between a top cover 902B of the box assembly 902 and the sprocket-bushing riser 903. The drive nut 904 may be pressed into a machine-out pocket of the driven sprocket 112, wherein the pocket is under-sized I comparison with the drive nut 904 and the driven sprocket is heated above 500 degrees Fahrenheit to accept the seating into, and press fit coupling of, the drive nut 904 with the driven sprocket 112.

The box assembly 902 is coupled to a motor housing 906 that encloses the motor 106. An adjustable motor mount 908 positions and maintains the motor 105 in relation to the twenty three tooth drive sprocket 108. A hingeable cover 910 may be opened or closed to expose the motor 106, the drive sprocket 108, drive key 102, the number forty link chain 110 (not shown) and other elements for removal, replacement or adjustment.

Referring now to the drive sprocket 108, the drive sprocket is captured between a UMHW washer 913 and a motor drive block 914 of the drive shaft 104. The UMHW washer 912 is disposed between a motor top plate 106A of the motor 106 and the drive sprocket 108. The motor drive block 914 has a larger cross-sectional area in the X-Z plane than a lower channel 1088 of the drive sprocket aperture 108A through which a drive shaft stem 1088 fully extends.

An upper channel 108C of the drive sprocket aperture 108A is sized to permit the drive sprocket 108 to fully rotate about the motor drive block 914 without substantive inhibition by the motor drive block 914 when the drive key 102 is removed from the upper channel 108C, as when the first actuation system 100 is placed into the second operational state by removal and decoupling of the drive key 102. Alternatively, the drive key 102 is sized and shaped to fit into the upper channel 108C of the drive sprocket 108A and to thereby place the alternate system 900 into the first operational state, wherein the drive key 102 is disposed between the driven sprocket 108 and the motor drive block 914 and the drive sprocket 108 is thereby entrained with the drive shaft 104.

It is preferable that the user decouple the drive key 102 from the upper channel 108C and the motor drive block 914 prior to applying manual force to the hand wheel 800 in an effort to manually turn the stem 116. With the alternate version system 900 placed into the second operational mode, the resistance of the motor 106 to the rotation of the drive sprocket 108 is substantively eliminated, other that friction force evidenced between the drive shaft 104 and the drive sprocket 108.

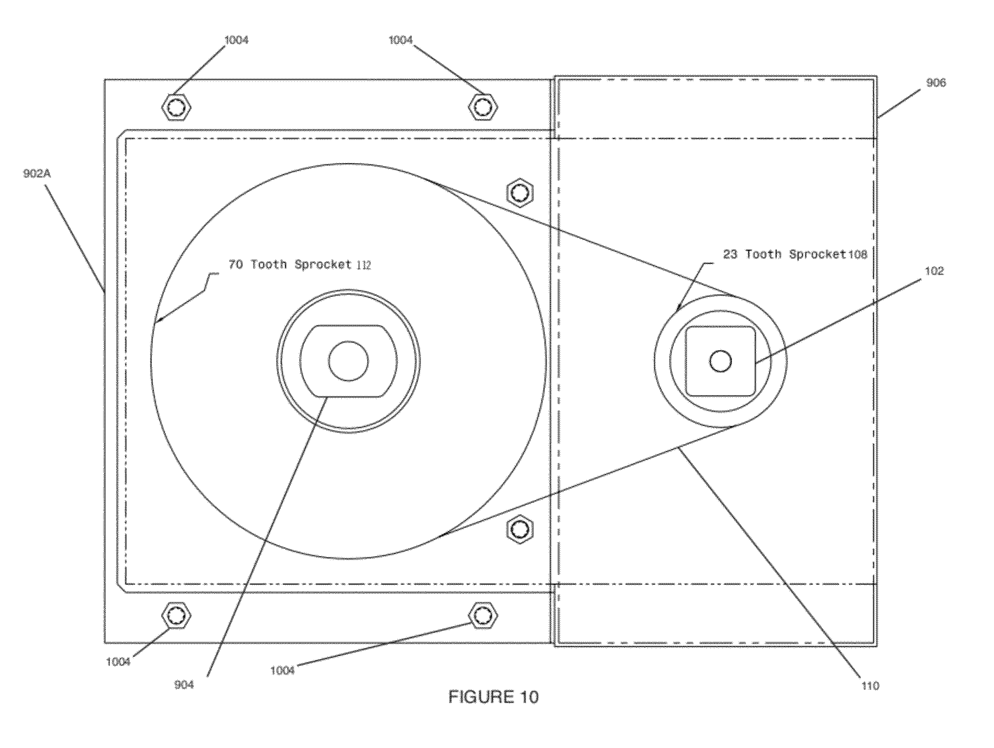

Referring now generally to the Figures and particularly to FIG. 10, FIG. 10 is a top view of the alternate system 900 wherein the drive sprocket 108 and the driven sprocket 112 are shown to be entrained by the link chain 110.

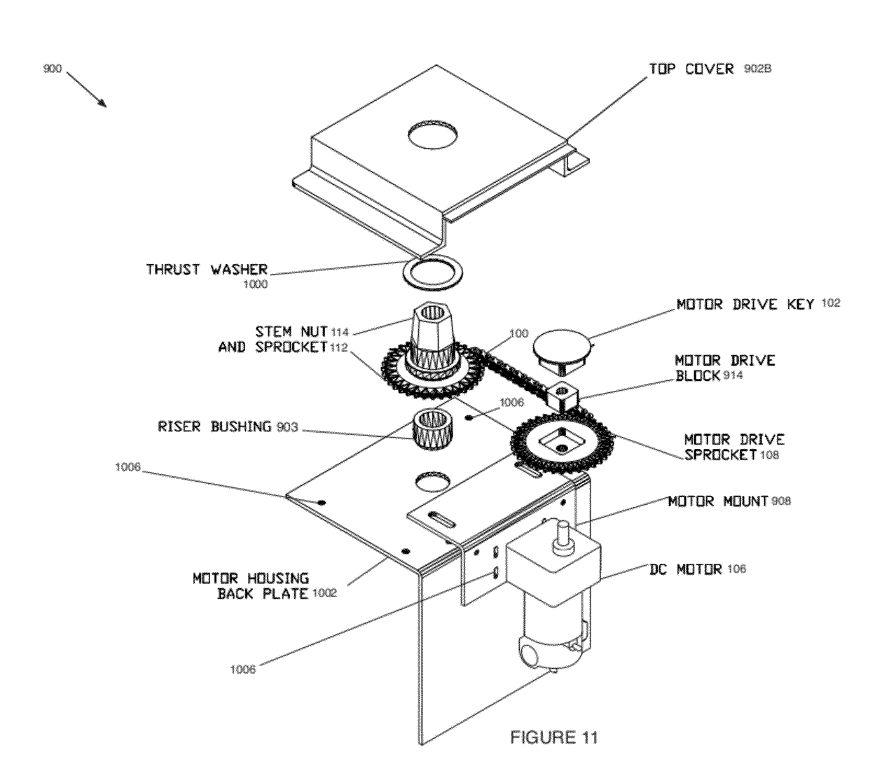

Referring now generally to the Figures and particularly to FIG. 11, FIG. 11 is an exploded perspective view of the alternate system 900 that further includes an optional thrust valve 1000 that may be disposed between the top cover 902B and the stem nut and through which the threaded stem 116 extends fully through.

It is understood that the hand wheel aperture 800A may be sized and shaped to extend about the stem 116 and engage with the Waterman/Fresno drive nut 904 sufficiently to enable transfer of manual force applied by the user to the hand wheel 800 to the threaded nut 114 and therefrom to the threaded stem 116, whereby the user may manually position the threaded stem 116 alternately up and down the Y-axis.

A motor housing back plate 1002 is coupled to the box bottom plate 902A by the adjustable motor mount 908. The motor housing back plate 1002, the box bottom plate 902A, the top cover 902B, the adjustable motor mount 908 and the motor 106 are coupled into the configurations illustrated herein by fasteners, such as threaded bolts 1004 engaged with threaded apertures 1006.

Various elements 102, 104, 108 through 1004 of the preferred embodiments 100, 200 and 400 may be made of or comprise metal, such as stainless steel, and/or other suitable metal, metal alloy, plastic or other suitable material known in the art.

The foregoing disclosures and statements are illustrative only of the present invention, and are not intended to limit or define the scope of the present invention. The above description is intended to be illustrative, and not restrictive. Although the examples given include many specificities, they are intended as illustrative of only certain possible applications of the present invention. The examples given should only be interpreted as illustrations of some of the applications of the present invention, and the full scope of the Present Invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

What is claimed is:

1. An apparatus comprising:
a drive shaft;
a drive sprocket;
a drive key, the drive key removably disposed between the drive shaft and the drive sprocket, wherein the drive key mechanically couples the drive shaft with the drive sprocket when disposed therebetween;
a driven sprocket;
a link chain mechanically enchaining the drive sprocket and the driven sprocket; and
a rotatable feature coupled with the driven sprocket, whereby the rotatable feature is entrained with the drive shaft when the drive key is disposed between the drive shaft and the drive sprocket.

2. The apparatus of claim 1, wherein the rotatable feature is a threaded nut.

3. The apparatus of claim 2, the apparatus further comprising a threaded stem extending through the threaded nut and engaging with an internal threaded channel of the threaded nut.

4. The apparatus of claim 2, wherein the threaded nut is rotatably coupled with a plate.

5. The apparatus of claim 3, wherein the threaded nut is rotatably coupled with a plate.

6. The apparatus of claim 3, wherein the threaded stem is coupled at a first end with a barrier of a gate, and positioning the threaded stem by rotation of the driven sprocket alternately open and closes the gate.

7. The apparatus of claim 6, wherein the gate is applied to control water flow.

8. The apparatus of claim 6, wherein the threaded nut is rotatably coupled with a plate.

9. The apparatus of claim 3, further comprising a hand wheel having an internal wheel threaded channel engaging with the threaded stem.

10. The apparatus of claim 9, wherein the hand wheel is removable from the threaded stem.

11. The apparatus of claim 1, further comprising a motor coupled with the drive shaft, whereby mechanical energy is transferred from the motor to the rotatable feature when the drive key is disposed between the drive shaft and the drive sprocket.

12. The apparatus of claim 11, further comprising a threaded stem extending through an internal threaded channel of the rotatable feature, whereby mechanical energy is transferred from the motor to the threaded stem when the drive key is disposed between the drive shaft and the drive sprocket.

13. The apparatus of claim 12, wherein rotatable feature is a threaded nut.

14. The apparatus of claim 12, further comprising a frame having a plate, wherein the rotatable feature is rotatably coupled with the plate and the motor is coupled with the frame.

15. The apparatus of claim 12, wherein the threaded stem is coupled at a first end with a barrier of a gate, and positioning the threaded stem by rotation of the driven sprocket alternately open and closes the gate.

16. The apparatus of claim 12, further comprising a hand wheel having an internal wheel threaded channel engaging with the threaded stem.

17. The apparatus of claim 15, wherein the hand wheel is removable from the threaded stem.

18. An apparatus comprising:
a drive shaft;
a drive pulley;
a drive key, the drive key removably disposed between the drive shaft and the drive pulley, wherein the drive key mechanically couples the drive shaft with the drive pulley when disposed therebetween;
a driven pulley;
a belt mechanically coupling the drive pulley and the driven pulley; and
a rotatable feature coupled with the driven pulley, whereby the rotatable feature is entrained with the drive shaft when the drive key is disposed between the drive shaft and the drive pulley.

19. a drive shaft;
a drive gear;
a drive key, the drive key removably disposed between the drive shaft and the drive g gear, wherein the drive key mechanically couples the drive shaft with the drive gear when disposed therebetween;
a driven gear;
a toothed belt mechanically coupling the drive gear and the driven gear; and
a rotatable feature coupled with the driven gear, whereby the rotatable feature is entrained with the drive shaft when the drive key is disposed between the drive shaft and the drive gear.

20. A method comprising:
a. providing an apparatus comprising a drive shaft, a drive sprocket, and a drive key, the drive key configured for removable positioning between the drive shaft and the drive sprocket enabling transfer of mechanical torque from the drive shaft to the drive sprocket;
b. positioning the drive key between the drive shaft and the drive sprocket. and the drive key thereby transferring mechanical torque from the drive shaft to the drive sprocket; and
c. removing the drive key from between the drive shaft and the drive sprocket and thereby decoupling the drive shaft and the drive sprocket.
